(19) United States
(12) Patent Application Publication
(10) Pub. No.: US 2026/0270874 A1
(43) Pub. Date: Sep. 10, 2026

(54) POWER SAVING ENHANCEMENTS USING A LOW-POWER WAKEUP SIGNAL

(71) Applicant: QUALCOMM Incorporated, San Diego, CA (US)

(72) Inventors: Linhai HE, San Diego, CA (US); Yuchul KIM, San Diego, CA (US); Ahmed ELSHAFIE, San Diego, CA (US); Zhikun WU, Beijing (CN); Peter GAAL, San Diego, CA (US); Wanshi CHEN, San Diego, CA (US); Juan MONTOJO, San Diego, CA (US); Le LIU, San Jose, CA (US)

(21) Appl. No.: 18/875,676

(22) PCT Filed: Jul. 15, 2022
(86) PCT No.: PCT/CN2022/105919

§ 371 Date: Dec. 16, 2024

(51) Int. Cl. H04W 52/02; H04W 68/00

(52) U.S. Cl. CPC H04W 52/0235; H04W 68/005

(57) ABSTRACT

A method of wireless communication at a UE includes monitoring for a low power wake up signal (LP-WUS) from a network node based on meeting at least one condition. The method further includes waking up to receive communication from the network node in response to receiving the LP-WUS.

### TECHNICAL FIELD

The present disclosure relates generally to communication systems, and more particularly, to wireless communicating including paging.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus monitors for a low power wake up signal (LP-WUS) from a network node based on meeting at least one condition. The apparatus wakes up to receive communication from the network node in response to receiving the LP-WUS.

In an aspect of the disclosure, a method, a computer-readable medium, and an apparatus are provided for wireless communication at a UE. The apparatus receives a first wake up signal (WUS) comprising a LP-WUS from a network node. The apparatus monitors for a second WUS from the network node in response to receiving the LP-WUS.

In an aspect of the disclosure, a method, a computer-readable medium, and an apparatus are provided for wireless communication at a network node. The apparatus transmits a first WUS comprising a LP-WUS for a UE. The apparatus transmits a second WUS for the UE. The apparatus transmits a page to the UE after transmitting the LP-WUS and the second WUS.

In an aspect of the disclosure, a method, a computer-readable medium, and an apparatus are provided for wireless communication at a network node. The apparatus obtains a request from a UE to use a LP-WUS. The apparatus transmits the LP-WUS for the UE in response to having data to transmit to the UE and based at least in part on the request.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4A illustrates an example diagram of discontinuous reception (DRX).

FIG. 4B, FIG. 4C, and FIG. 4D illustrate examples of utilizing a low power wakeup signal (LP-WUS) and a physical downlink control channel wakeup signal (PDCCH-WUS) for paging in a cell.

FIG. 5 is a diagram illustrating an example of utilizing a LP-WUS in conjunction with a PDCCH-WUS for paging in a cell.

FIG. 6 is a diagram illustrating an example of utilizing a LP-WUS for selected UEs for paging in a cell.

FIG. 7 is a diagram illustration example communications between a UE, a base station, and an Access and Mobility Management Function (AMF).

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a diagram illustrating an example of a hardware implementation for an example apparatus and/or UE.

FIG. 13 is a diagram illustrating an example of a hardware implementation for an example network entity.

FIG. 14 is a diagram illustrating an example of a hardware implementation for an example network entity.

### DETAILED DESCRIPTION

A UE may be configured with resources to monitor for a wakeup signal (WUS), such as a PDCCH-WUS. When configured, the UE wakes up a configurable amount of time before a start of discontinuous reception (DRX) cycle. The UE then checks for the WUS using a main radio of the UE. If the UE does not receive the WUS, the UE returns to sleep for the next DRX cycle. Waking up the main radio consumes UE power. Aspects presented herein enable a UE to receive a LP-WUS in place of or supplemental to a WUS, e.g., which may be referred to as a higher power WUS. In some aspects, the UE monitors for a LP-WUS from a network node based on meeting at least one condition (e.g., a location of a UE within a cell, a mobility condition of the UE, a signal measurement associated with the LP-WUS, etc.). The UE may use a reduced amount of power to monitor for and receive the LP-WUS relative to the higher amount of power to monitor for an receive the higher power WUS. The UE may wake up to receive communication from the network node in response to receiving the LP-WUS. Thus, the UE may consume less power monitoring for the LP-WUS in comparison to monitoring for the higher power WUS. In some aspects, the UE receives a first WUS comprising a LP-WUS from a network node. The UE monitors for a second WUS, e.g., a higher power WUS, from the network node in response to receiving the LP-WUS. Thus, the UE may take advantage of the benefits of a WUS (wide coverage) while also taking advantage of potential for increased power saving based on the LP-WUS (e.g., lower UE power consumption to monitor for the LP-WUS).

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB (e.g., which may be referred to as a gNB), access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

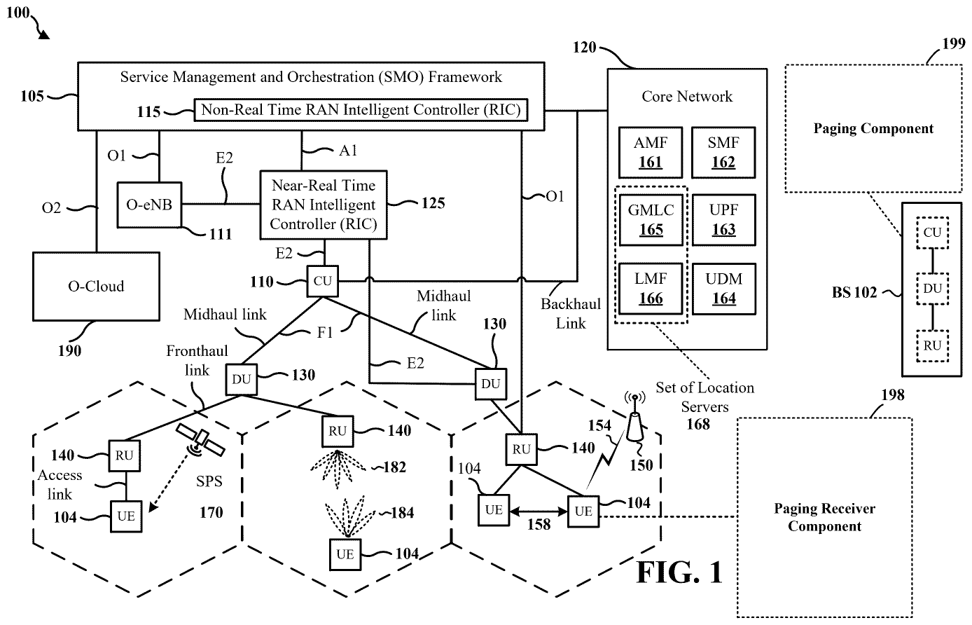

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a paging receiver component 198 that is configured to monitor for a LP-WUS from a network node based on meeting at least one condition and wake up to receive communication from the network node in response to receiving the LP-WUS. In certain aspects, the UE 104 may include a paging receiver component 198 that is configured to receive a first WUS comprising a LP-WUS from a network node and monitor for a second WUS from the network node in response to receiving the LP-WUS. In certain aspects, the base station 102 may include a paging component 199 that is configured to transmit a first WUS comprising a LP-WUS for a UE, transmit a second WUS for the UE, and transmit a page to the UE after transmitting the LP-WUS and the second WUS. In certain aspects, the base station 102 may include a paging component 199 that is configured to obtain a request from a UE to use a LP-WUS and transmit the LP-WUS for the UE in response to having data to transmit to the UE and based at least in part on the request. Although the following description may be focused on 5G NR, the concepts described herein may be applicable to other similar areas, such as LTE, LTE-A, CDMA, GSM, and other wireless technologies.

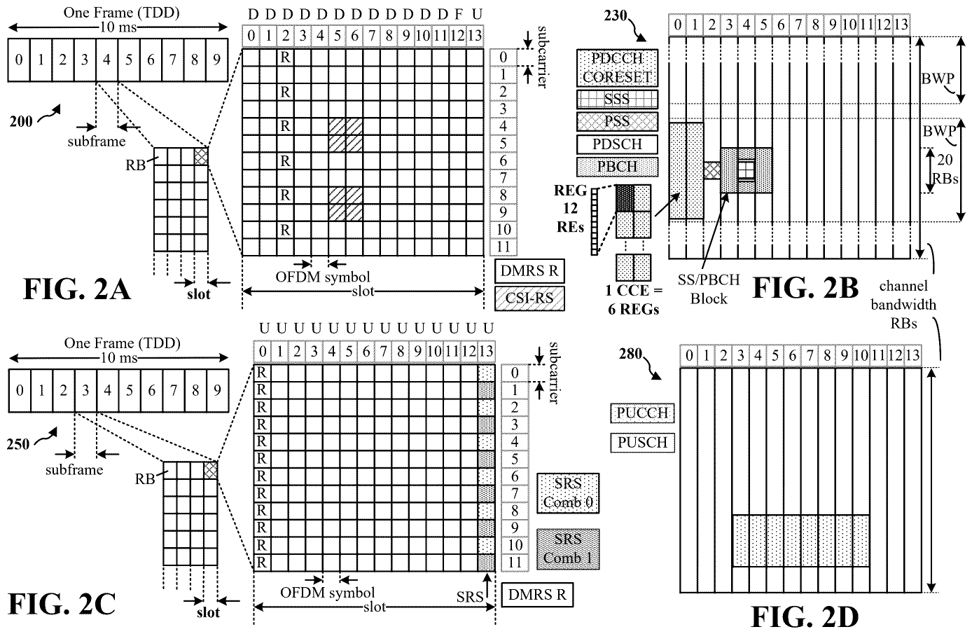

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

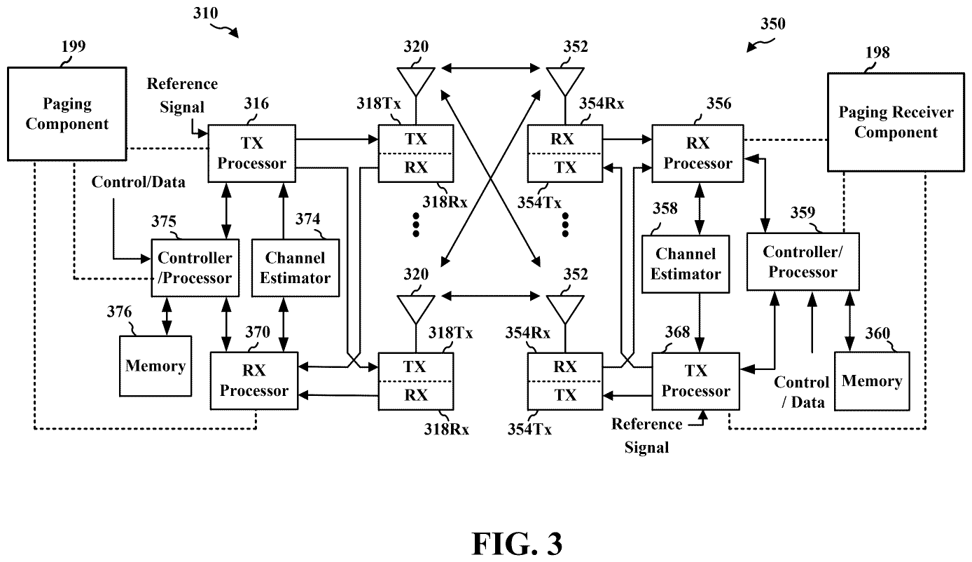

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the paging receiver component 198 of FIG. 1.

At least one of the TX processor 316, the RX processor 370, and the controller/processor 375 may be configured to perform aspects in connection with the paging component 199 of FIG. 1.

In RRC idle and inactive states, radio resource management (RRM) and paging consume significant UE power. In an example, in RRM, the UE periodically performs layer 3 reference signal received power (L3-RSRP) measurements on SSBs transmitted by a serving cell of the UE and neighbor cells of the UE. Such L3-RSPRP measurements consume power. In another example, in paging, the UE periodically monitors a paging occasion (PO) during each idle discontinuous reception (I-DRX) cycle. In a DRX mode, the UE may monitor a PDCCH channel discontinuously using a sleep and wake cycle, e.g., DRX OFF durations and DRX ON durations. When the UE is in an RRC connected state, the DRX may also be referred to as Connected Mode DRX (C-DRX). If the UE is in an RRC idle state, the DRX may be referred to as I-DRX. In a non-DRX mode, the UE monitors for PDCCH in each subframe to check whether there is downlink data available. Continuous monitoring of the PDCCH uses more battery power at the UE, and DRX conserves battery power at the UE.

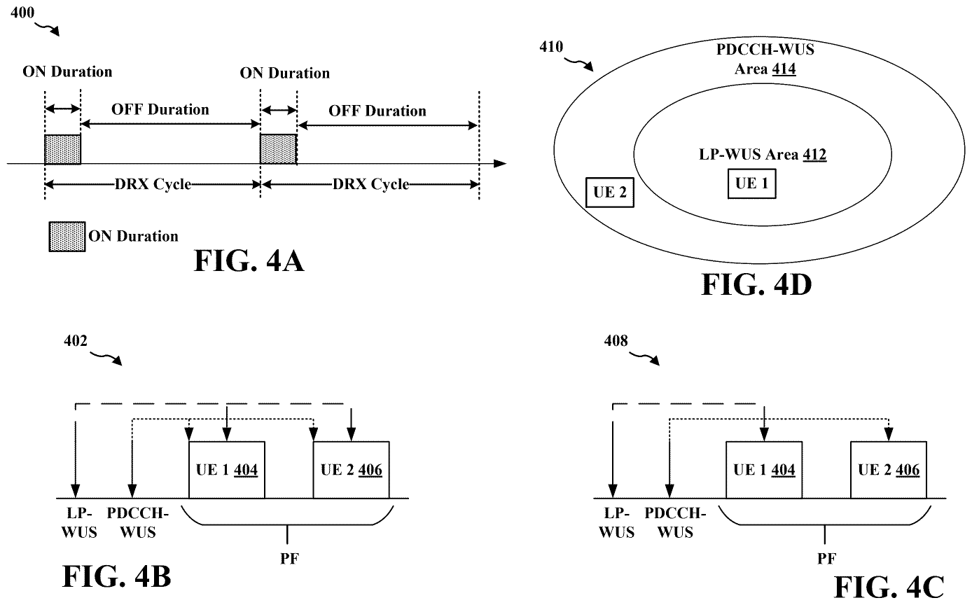

FIG. 4A illustrates an example of a DRX cycle 400 including periodic ON durations during which the UE monitors for PDCCH and OFF durations during which the UE may not monitor for the PDCCH. The OFF duration may be referred to as a DRX opportunity, in some aspects. During the OFF duration, the UE does not monitor for PDCCH. The UE may enter a sleep mode or a low power mode in which the UE minimizes power consumption by shutting down an RF function without detecting communication from the base station.

The base station may send a wake-up signal (WUS) to a UE in advance of a paging occasion (PO) when the base station will transmit communication to the UE. If the UE receives a WUS, the UE may wake-up by preparing to receive the communication during the PO. If the UE does not receive a WUS, the UE may return to the sleep mode. A UE may be configured with resources to monitor for the WUS. When configured with such resources, the UE wakes up a configurable amount of time before a start of a long discontinuous reception (DRX) cycle and checks, e.g., monitors, for the WUS. If the UE does not receive the WUS, the UE returns to sleep for the next long DRX cycle. WUSs may reduce power consumption for UEs. In some configurations, a WUS may be transmitted over the PDCCH (such a wakeup signal may be referred to as a PDCCH-WUS)

In some configurations, a UE may be equipped with a low power wakeup radio (LP-WUR) that utilizes less battery power than another radio (e.g., a main radio) of the UE. In an example, the LP-WUR may utilize less than 1 mA. The LP-WUR may be configured to receive a low power wakeup signal (LP-WUS). A UE that utilizes the LP-WUS for wakeup purposes may consume less power than a UE that utilizes the PDCCH-WUS for wakeup purposes. The LP-WUS may utilize a simplified modulation scheme in comparison to a WUS (e.g., which may be referred to as a higher power WUS). As an example, the LP-WUS may be based on an off keying (OOK) modulation scheme. The OOK modulation scheme may lead to a smaller a payload size for a LP-WUS. Aspects presented herein provide for use of an LP-WUS in different contexts and/or according to different criteria in order to reduce UE power consumption.

To address issues pertaining to UE power consumption, enhancements to UE paging procedures are described herein. In some aspects, a LP-WUS may have an increased sensitivity compared to a WUS such as PDCCH WUS. A large number of LP-WUS repetitions may be used to provide a similar level of coverage as a paging channel. The increased repetitions may use additional wireless resources and may cause the UE to wake up more frequently to monitor for the LP-WUS. The LP-WUS may have a reduced payload in comparison to a WUS such as PDCCH. In one aspect, a base station may send a wakeup indication in both a LP-WUS and a PDCCH-WUS to a UE, and the UE may choose whether to monitor for the LP-WUS and/or the PDCCH WUS, e.g., based on a condition at the UE. This enables the UE to save power, in some circumstances by monitoring for the LP-WUS using a low power receiver without added signaling overhead to inform the network of the particular WUS that the UE will monitor. In a further aspect, UEs located near a cell edge may be configured to utilize the PDCCH-WUS, and UEs that are not located near the cell edge may be configured to utilize the LP-WUS. The different configurations may enable UEs that are closer to a base station to save power by monitoring for the LP-WUS, while enabling better coverage for the UEs at cell edge. The use of different configurations may enable the base station to use fewer resources by transmitting a LP-WUS and not a PDCCH-WUS for UEs that are closer to the base station. In another aspect, each UE in a cell may be configured to utilize both a LP-WUS and a PDCCH-WUS in a two-stage wakeup procedure. In yet another aspect, some UEs (e.g., power sensitive UEs, UEs, with a low paging probability, etc.) in a cell may be configured to utilize a LP-WUS and other UEs may not be configured to monitor for the LP-WUS. The use of the two-stage wake-up may improve WUS coverage through the second stage WUS, while enabling a UE that does not receive the first stage WUS to avoid waking up a higher power receiver. Through use of a LP-WUS, UE power consumption may be reduced.

In an example, a UE monitors for a LP-WUS from a network node based on meeting at least one condition. The UE wakes up to receive communication from the network node in response to receiving the LP-WUS. By monitoring for a LP-WUS (as opposed to a PDCCH-WUS) based on at least one condition being met (e.g., a location of the UE within a cell, mobility conditions of the UE, etc.), UE power consumption may be reduced. In another example, a UE receives a LP-WUS from a network node. The UE monitors for a WUS from the network node in response to receiving the LP-WUS. The WUS may be referred to as a higher power WUS that refers to a higher amount of power use at the UE to receive the WUS. The higher power WUS may include a more complex modulation scheme than the LP-WUS, and reception/decoding the higher power WUS may use more power, or a higher power receiver, at the UE. In an example, the higher power WUS may be a PDCCH-WUS. By first monitoring for the WUS after receiving the LP-WUS, the UE may be able to realize the power consumption savings associated with the LP-WUS while still taking advantage of wider coverage of the higher power WUS.

FIGS. 4B, 4C, and 4D illustrate example aspects of utilizing a LP-WUS and a PDCCH-WUS for paging in a cell. FIG. 4B illustrates a first configuration 402 in which a network sends both a LP-WUS and a PDCCH-WUS for UEs, e.g., without distinguishing between UEs that are closer to a cell edge and UEs that are closer to a base station. In the first configuration 402, a base station (e.g., the base station 102, the base station 310) transmits the LP-WUS and the PDCCH-WUS to a first UE 404 and a second UE 406 to indicate that the base station will send information for the UEs in a paging frame (PF). The first UE 404 and the second UE 406 may each determine which type of WUS to utilize, e.g., for a particular paging occasion. For instance, the first UE 404 may decide to utilize the LP-WUS and the second UE 406 may decide to utilize the PDCCH-WUS. In an example, the first UE 404 and the second UE 406 may select the LP-WUS or the PDCCH-WUS based upon a condition experienced at the UE, such as a measured reference signal received power (RSRP) relative to an RSRP threshold. If the UE measures an RSRP for a signal received from the base station that is equal to or above the RSRP threshold, the UE may monitor for the LP-WUS and not the PDCCH-WUS. If the UE measures an RSRP that is below the RSRP threshold, the UE may instead monitor for the PDCCH-WUS. In some aspects, the UE may determine whether to monitor for the LP-WUS or the PDCCH-WUS based on a location of the UE within a cell, e.g., monitoring for the LP-WUS if the UE is closer to a cell center and monitoring for the PDCCH-WUS if the UE is closer to a cell edge. In some aspects, the UE may determine whether to monitor for the LP-WUS or the PDCCH-WUS based on a mobility state of the UE, e.g., monitoring for the LP-WUS if the UE has a low mobility or is stationary, and monitoring for the PDCCH-WUS if the UE has a higher mobility state.

FIG. 4C illustrates a second configuration 408 of a base station transmitting LP-WUS for UEs meeting a one or more criteria and transmitting PDCCH-WUS for other UEs. As described in connection with FIG. 4B, the condition may be based on an RSRP measurement reported by the corresponding UE, a location of the UE within a cell, a mobility state of the UE, etc. In the second configuration 408, as shown in FIG. 4D, a cell 410 includes a LP-WUS area 412 located near, or surrounding, a center of the cell 410 and a PDCCH-WUS area 414 located closer to an edge of the cell 410, e.g., at a greater distance from a base station. In an example involving the second configuration 408, the first UE 404 is located in the LP-WUS area 412, and the second UE 406 is located in the PDCCH-WUS area 414. In the second configuration 408, the base station may transmit the LP-WUS to UEs (e.g., the first UE 404) located in the LP-WUS area 412 (i.e., UEs that are not located near a cell edge). Additionally or alternatively, the base station transmits the LP-WUS to UEs that have low mobility or that are stationary, to UEs that report an RSRP measurement above an RSRP threshold, or to UEs for which the base station measures an uplink signal having an RSRP measurement above an RSRP threshold. In the second configuration 408, the base station transmits the PDCCH-WUS to UEs (e.g., the second UE 406) that do not meet the one or more criteria, e.g., such as UEs located in the PDCCH-WUS area 414 (i.e., UEs that are located near the cell edge).

In one aspect, the LP-WUS area 412, the PDCCH-WUS area 414, and low mobility UEs may be determined by criteria. Such criteria may include not at cell edge (NACE) criteria and low mobility criteria for RRM relaxation. In one aspect, when a UE does not meet the criteria for a LP-WUS, the UE may fall back to utilizing PDCCH-WUS or another type of paging. When fall back occurs, the UE may utilize non-access stratum (NAS) signaling to update the AMF of the core network (CN) as to which type of paging procedure is to be utilized. In one aspect, the CN may assign UEs with different paging subgroups for LP-WUS and PDCCH-WUS. For instance, the CN may configure different number of paging subgroups for LP-WUS and PDCCH-WUS due to differences in respective payload sizes of the LP-WUS and the PDCCH-WUS.

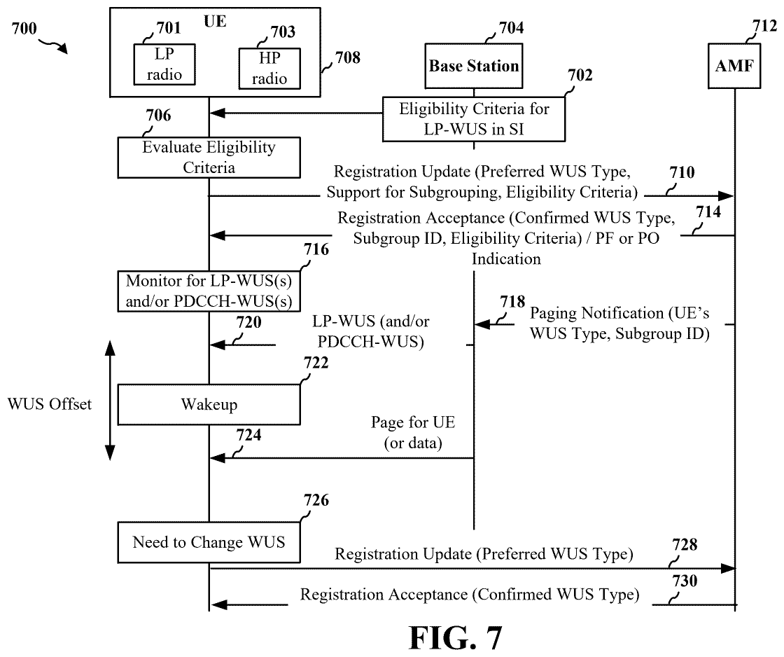

In some aspects, a UE may request to use an LP-WUS, such as if the UE meets LP-WUS eligibility criteria, as described in more detail in connection with FIG. 7.

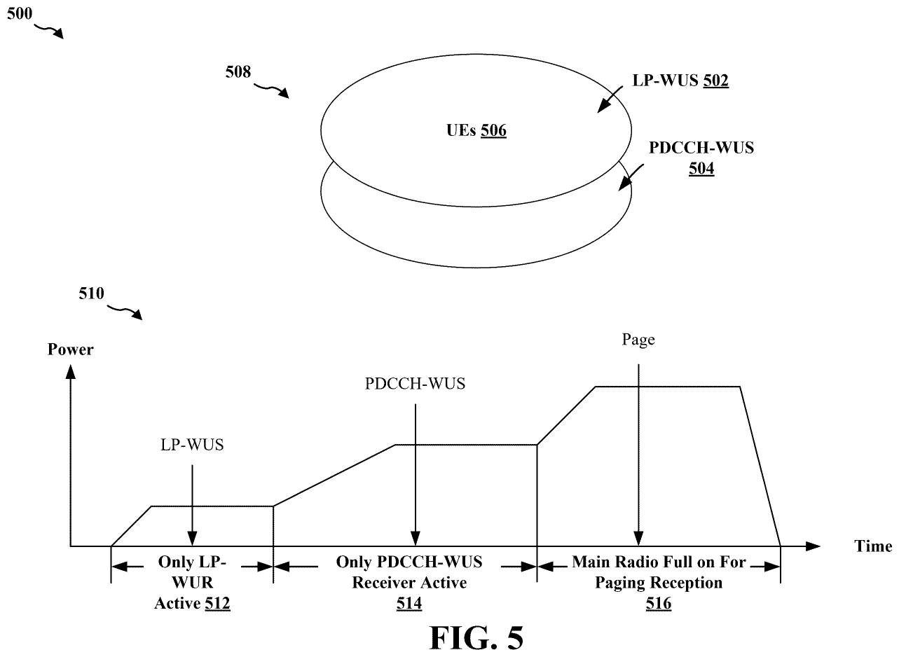

FIG. 5 is a diagram 500 illustrating an example of utilizing a LP-WUS in conjunction with a PDCCH-WUS for paging in a cell. As shown by the diagram 500, a base station may transmit a LP-WUS 502 and a PDCCH-WUS 504 to UEs 506 within a cell 508 in a two-stage wakeup process. In some aspects, the two-stage wake up procedure may be used for each UE, e.g., regardless of mobility, location, signal measurements of the UEs. In other aspects, the two-state wake up procedure may be used for a subset of UEs that meet one or more conditions. The example in FIG. 5 may be performed without NAS signaling.

The two-stage wakeup process may utilize a relatively high repetition level for the LP-WUS to ensure that the LP-WUS has the same or similar coverage as the PDCCH-WUS. For instance, the base station may transmit the LP-WUS at a first periodicity, where the first periodicity is less than a second periodicity used by the base station to transmit the PDCCH-WUS. One or more POs may be aggregated in a LP-WUS to reduce transmission periodicity. In an example, more than two POs may be aggregated in a LP-WUS to reduce resources consumed by the UE. Granularity of the LP-WUS can be at a level of a PO or a set of POs (instead of paging subgroups as in a PDCCH-WUS). In an example, a bit in the LP-WUS indicates wakeup if any UE in a PO or a set of POs has a page. If the LP-WUS indicates for the UEs in the PO or set of POs to wake up, the UEs may then monitor for the other WUS to confirm whether to fully wake up to receive communication from the network. If the UE does not receive the other WUS indicating that the network has a page for the UE, the UE can return to the sleep mode.

The diagram 500 includes a graph 510 of power versus time of a UE that illustrates an example of the two-stage wakeup process. During a first time period 512, a LP-WUR of a UE is powered on, while a PDCCH-WUS receiver and a main radio of the are powered off. In an example, the UE receives a LP-WUS that includes a bit indicating wakeup. In an example, the LP-WUS covers all UEs in a group of ten POs. When the UE receives the LP-WUS, the UE powers on a PDCCH-WUS receiver for a second time period 514. As noted above, the LP-WUS may include aggregated POs. The LP-WUR and the main radio are powered off during the second time period 514. As indicated in the graph 510, the PDCCH-WUS receiver may consume more power than the LP-WUR when powered on. Following the example above, the PDCCH-WUS may include information as to which PO in the group of ten POs will have a paging message thereon. When the UE receives a PDCCH-WUS, the UE may turn on the main radio for paging reception for a third time period 516. A payload size of the PDCCH-WUS may be greater than a payload size of the LP-WUS. As indicated in the graph 510, the main radio may consume more power than the PDCCH-WUS receiver when powered on. The PDCCH-WUS may provide a confirmation to the UE that the network does have communication for the UE, and the PDCCH-WUS may carry additional information for the UE beyond the information in a payload of the LP-WUS.

In one aspect, the UE may decide to ignore the PDCCH-WUS. For example, if the UE determines that a false paging alarm rate is below a threshold level (e.g., indicating that the reception of the LP-WUS has been accurate in the past), the UE can skip monitoring for the PDCCH-WUS and proceed to activate the main radio when the UE receives the LP-WUS.

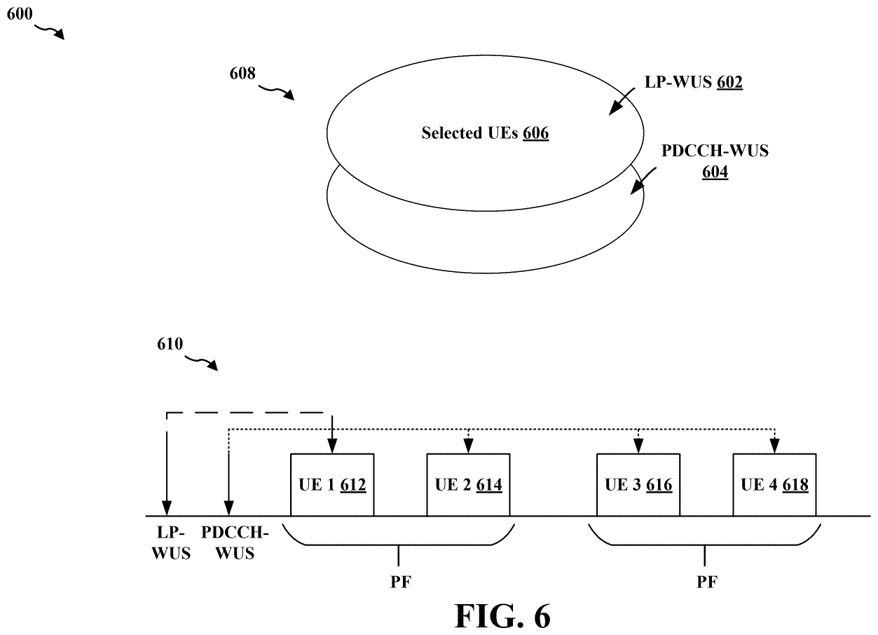

FIG. 6 is a diagram 600 illustrating an example of utilizing a LP-WUS for selected UEs for paging in a cell. In a configuration indicated by the diagram 600, a base station (e.g., the base station 102, the base station 310) transmits a LP-WUS 602 and a PDCCH-WUS 604 to selected UEs 606 within a cell 608. The selected UEs 606 may be selected based upon criteria such as power sensitivity and/or low paging probability, or other criteria indicating a type of the UE. The selected UEs 606 may be assigned to a separate set of PF/POs that are configured with a resources to monitor for the LP-WUS.

The diagram 600 illustrates a configuration 610 of utilizing LP-WUSs and PDCCH-WUSs. In the configuration 610, a base station transmits the LP-WUS to a first UE 612 in a cell. The first UE 612 is within the selected UEs 606. In an example, the first UE 612 is power sensitive and/or has a low paging probability. In the configuration 610, the base station transmits the PDCCH-WUS to a second UE 614, a third UE 616, and a fourth UE 618. The second UE 614, the third UE 616, and the fourth UE 618 are not in the selected UEs 606.

In one aspect, the UE may send a request for use of a LP-WUS to the network, e.g., to an AMF of the CN using NAS. The AMF may grant or reject the request. The AMF may grant (or reject) the request based upon certain factors, such as a subscription of the UE, an estimated paging probability of the UE, etc. The AMF may assign the UE to a paging subgroup specific to the LP-WUS.

The AMF sends an indication as to whether the request is granted or rejected to the UE. When the request is granted, the UE determines a PO among POs associated with the LP-WUS. When the AMF sends a paging notification to the base station (i.e., RAN), the paging notification includes an indication as to whether the UE uses a LP-WUS. The base station may advertise locations of a set of POs with LP-WUS in SI. The set of POs with LP-WUS is disjoint from other POs. When the UE roams into a cell that does not support LP-WUS, the UE may fall back to monitoring POs that are not associated with LP-WUS (e.g., POs associated with PDCCH-WUS).

FIG. 7 is a diagram 700 that illustrates example communications between a UE 708 and a network, such as a base station 704, and an AMF 712. In some aspects, the UE 708 may include multiple receivers, or radios. For example, the UE 708 may include a lower power radio 701 (or low power receiver) and a higher power radio 703 (or high power receiver). As depicted in the diagram 700, at 702, a base station 704 (e.g., the base station 102, the base station 310, etc.) may provide eligibility criteria for LP-WUS, e.g., such as broadcasting the criteria in system information (SI). In an example, the eligibility criteria may include NACE and low mobility criteria for RRM relaxation. In another example, the eligibility criteria include one or more of a RSRP of a downlink reference signal of a UE meeting a threshold, a location of the UE within a cell, a location of the UE within a cell, and/or reception of an indication for a paging subgroup associated with the LP-WUS. At 706, a UE 708 (e.g., the UE 104, the UE 350, etc.) evaluates the eligibility criteria. In some aspects, as shown at 710, if the UE 708 meets the eligibility criteria, the UE 708 may send a registration update request to the network, e.g., to an AMF 712 of a CN (e.g., the core network 120) via a base station 704. For instance, the UE 708 may send the registration update request to the AMF 712 via NAS signaling that the UE 708 transmits to the base station 704. The registration update request may include a preferred WUS type (e.g., LP-WUS, PDCCH-WUS, a combination of a LP-WUS and PDCCH-WUS, another WUS, no WUS, etc.) and an indication as to whether subgrouping is supported. In one example, the registration update request may include a request to use a LP-WUS when the eligibility criteria are met. In another example, the registration update request includes a request to first use a LP-WUS and subsequently use a PDCCH-WUS in response to receiving the LP-WUS (two-stage wakeup). The UE may send the request in connection with any of the examples described in connection with FIG. 4A-D, 5, or 6.

The network, e.g., the AMF 712 of the CN, may decide to grant the registration update request based on additional factors such as a type of the UE 708. The AMF 712 can accept the request based on a subscription of the UE 708 or an estimated paging probability for the UE 708. The AMF 712 of the CN may then assign the UE 708 with a paging subgroup specific for a LP-WUS. At 714, the AMF 712 of the CN sends a registration acceptance to the UE 708 (e.g., via NAS signaling). The registration acceptance includes a confirmation of the WUS type and an identifier for the paging subgroup. The registration acceptance may also indicate a PF or a PO associated with the LP-WUS. In one aspect, if the registration update request is not accepted by the AMF 712 of the CN, or if the UE 708 does not meet the eligibility criteria, the UE 708 may send an indication to the AMF 712 of the CN to use a PDCCH-WUS (or another WUS) as a fall back.

In some aspects, the UE may determine to monitor for an LP-WUS and/or a PDCCH-WUS without sending a request to the network.

At 716, the UE 708 begins to monitor for a LP-WUS (or LP-WUSs) and/or a PDCCH-WUS (or PDCCH-WUS(s)). For instance, in one configuration, the UE 708 begins to monitor for a LP-WUS. The UE may monitor for a LP-WUS or a PDCCH-WUS, as selected by the UE in FIG. 4B-D. The UE may monitor for a LP-WUS and a PDCCH-WUS as described in connection with FIG. 5. The UE may monitor for a type of WUS according to a configuration, e.g., as described in connection with FIG. 6.

At 718, the AMF 712 of the CN sends a paging notification to the base station 704. The paging notification includes an indication of the WUS type of the UE 708 (e.g., LP-WUS, PDCCH-WUS, another wakeup signal, no WUS, etc.) and the identifier for the paging subgroup. At 720, the base station 704 sends a LP-WUS or a PDCCH-WUS based upon the paging notification received by the base station 704 by the AMF 712 of the CN, e.g., and based on any of the aspects described in connection with FIGS. 4-6. At 722, in response to receiving the LP-WUS or the PDCCH-WUS, the UE 708 wakes up for communication. At 724, after a WUS offset, the base station 704 sends a page (or data) to the UE 708.

In another aspect, at 716, the UE 708 first monitors for a LP-WUS and then monitors for a PDCCH-WUS when the LP-WUS is received. When the PDCCH-WUS is received, at 722, the UE 708 wakes up for communication. At 724, after a WUS offset, the base station 704 sends a page (or data) to the UE 708.

In another aspect, at 716, the UE 708 first monitors for a LP-WUS and then monitors for a PDCCH-WUS when the LP-WUS is received. When the PDCCH-WUS is received, at 722, the UE 708 wakes up for communication. Subsequently, at 716, the UE 708 monitors for and receives a second LP-WUS. At 722, the UE 708 wakes up to receive communication without monitoring for a corresponding PDCCH-WUS based on a paging alarm rate being below a threshold.

At 726, the UE 708 may determine that the WUS type is to be changed. For instance, the UE 708 may determine that the UE 708 has moved from a center of a cell to a cell edge and as a result, a PDCCH-WUS is to be used in place of a LP-WUS. At 728, the UE 708 sends another registration update request to the AMF 712 of the CN, where the registration update request includes a new (preferred) WUS type (which may be different than the preferred WUS type discussed at 710). At 730, the AMF 712 sends another registration acceptance to the UE 708 that includes a confirmation of the new (preferred) WUS type.

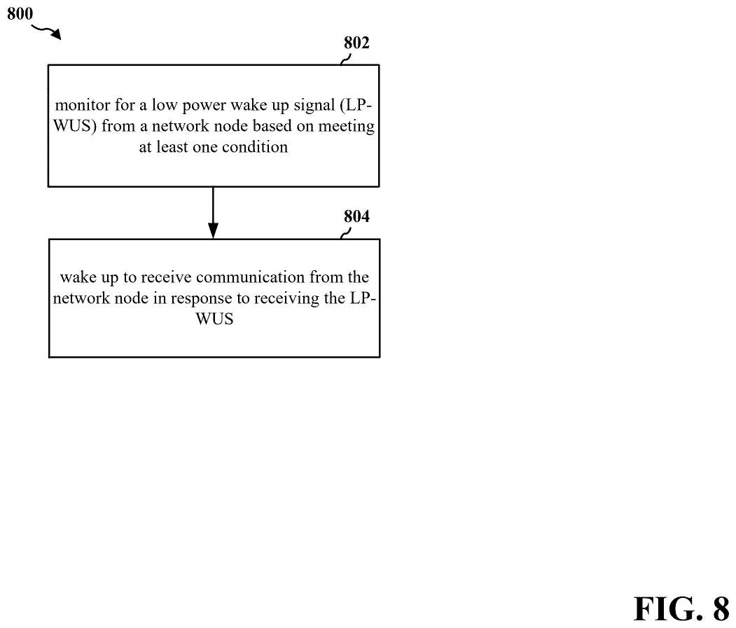

FIG. 8 is a flowchart 800 of a method of wireless communication. The method may be performed by a UE (e.g., the UE 104, the UE 350, the apparatus 1204). In an example, the method (including the various configurations described below) may be performed by the paging receiver component 198. The method may be associated with various advantages for the UE, such as reduced UE power consumption, while also providing for improved LP-WUS coverage.

At 802, the UE monitors for a LP-WUS from a network node based on meeting at least one condition. For example, referring to FIG. 7, at 716, the UE 708 monitors for a LP-WUS based on an evaluation of eligibility criteria at 706. In another example, referring to FIG. 4B-D, a UE may monitor for a LP-WUS when the UE is in the LP-WUS area 412. In yet another example, referring to FIG. 6, a UE may monitor for a LP-WUS when it is selected (e.g., in the selected UEs 606). The monitoring may be performed, e.g., by the paging receiver component 198.

At 804, the UE wakes up to receive communication from the network node in response to receiving the LP-WUS. For example, referring to FIG. 7, at 722, the UE 708 wakes up in response to receiving a LP-WUS. The waking up may be performed, e.g., by the paging receiver component 198.

In one configuration, the at least one condition is based on at least one of a RSRP of a downlink reference signal of the UE meeting a threshold, a location of the UE within a cell, a mobility condition of the UE, or reception of an indication for a paging subgroup associated with the LP-WUS. For example, referring to FIG. 7, the UE 708 evaluates eligibility criteria at 706.

In one configuration, the UE may transmit to the network node, a request to use the LP-WUS in response to meeting the at least one condition. For example, referring to FIG. 7, at 710, the UE 708 sends a registration update request that may include eligibility criteria. In such a configuration, the UE may receive a response accepting use of the LP-WUS for the UE, where the UE monitors for the LP-WUS after receiving the response. For example, referring to FIG. 7, at 714, the receives a registration acceptance.

In one configuration, the LP-WUS is a first WUS and the UE may switch to monitoring for a second WUS in response to not meeting the at least one condition. For example, referring to FIG. 7, at 726, the UE 708 may change WUS types in response to evaluation of eligibility criteria.

In one configuration, the UE may monitor for the LP-WUS using a first receiver and may monitor for the second WUS using a second receiver that uses more power than the first receiver. For example, referring to FIG. 1, the paging receiver component 198 may monitor for a LP-WUS via a first receiver (e.g., such as 701) and monitor for a PDCCH-WUS via a second receiver (e.g., such as 703), where the second receiver uses more power than the first receiver.

In one configuration, the UE may transmit, to the network node, an indication of a change to the second WUS in response to not meeting the at least one condition. For example, referring to FIG. 7, at 728, the UE may transmit a registration update request in response to evaluating eligibility criteria.

In one configuration, the second WUS may comprise a PDCCH-WUS. For example, referring to FIGS. 4 and 6, the first configuration 402, the second configuration 408, and the configuration 610 illustrate PDCCH-WUSs. In another example, referring to FIG. 7 at 720, the UE 708 may receive a PDCCH-WUS.

In one configuration, the UE may monitor for the LP-WUS using a first receiver, where waking up to receive communication from the network node in response to receiving the LP-WUS comprises waking up a second receiver that uses more power than the first receiver. For example, referring to FIG. 1, the paging receiver component 198 may include a first receiver for monitoring a LP-WUS and a second receiver that is woken up to receive communications, where the second receiver uses more power than the first receiver.

In one configuration, the UE may receive, from the network node, an indication to use a paging frame or a paging occasion associated with the LP-WUS, where the UE monitors for the LP-WUS in response to the indication from the network node. For example, referring to FIG. 7, at 714 the UE 708 may receive an indication to use a paging frame or paging occasion.

In one configuration, the indication may be received in a system information broadcast or in dedicated signaling. For example, referring to FIG. 7, at 714, the indication may be received in a system information broadcast or in dedicated signaling.

In one configuration, the communication may comprise a page. For example, referring to FIG. 7, at 724, the UE receives a page.

In one configuration, the communication may comprise data. For example, referring to FIG. 7, at 724, the UE receives data.

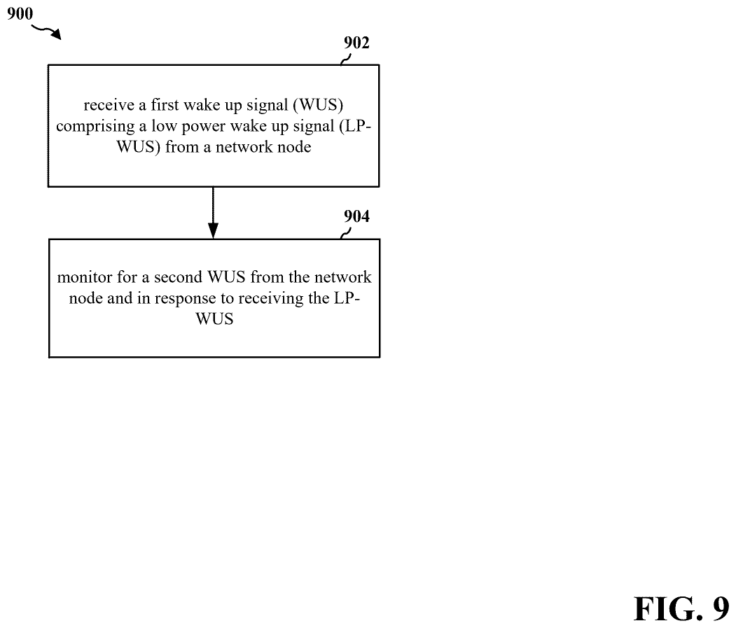

FIG. 9 is a flowchart 900 of a method of wireless communication. The method may be performed by a UE (e.g., the UE 104, the UE 350, the apparatus 1204). In an example, the method (including the various configurations described below) may be performed by the paging receiver component 198. The method may be associated with various advantages for the UE, such as reduced UE power consumption. At 902, the UE receives a first WUS comprising a LP-WUS from a network node. For example, referring to FIG. 7, at 720 the UE 708 may receive a LP-WUS. In another example, referring to FIG. 5, at a first time period 512, a UE receives a LP-WUS.

At 904, the UE monitors for a second WUS from the network node and in response to receiving the LP-WUS. For example, referring to FIG. 7, at 720, the UE 708 may receive a PDCCH-WUS. In another example, referring to FIG. 5, a UE receives a PDCCH-WUS during a second time period 514.

In one configuration, the UE may wake up to receive communication from the network node in response to receiving the second WUS. For example, referring to FIG. 7, at 722, the UE may wake up to receive communication in response to receiving the PDCCH-WUS. In another example, referring to FIG. 5, the UE wakes up a main radio for paging reception during a third time period 516.

In one configuration, the LP-WUS may be for multiple UEs associated with a PO or a PO set, and the second WUS may be for a subset of the multiple UEs associated with a paging subgroup. For example, referring to FIG. 7, at 714, the registration acceptance may include PO (or PO set) related information as well as paging subgroup information.

In one configuration, the UE may receive a second LP-WUS and the UE may wake up to receive second communication from the network node without monitoring for a corresponding second WUS based on a paging alarm rate being below a threshold. For example, referring to FIG. 7, at 716 the UE 708 may monitor for a subsequent LP-WUS and at 722 the UE 708 may wakeup to receive a communication without monitoring for a corresponding PDCCH-WUS.

In one configuration, the second WUS may comprise a PDCCH-WUS. For example, referring to FIG. 5, a PDCCH-WUS is depicted. In another example, referring to FIG. 7 at 720, the UE 708 may receive a PDCCH-WUS.

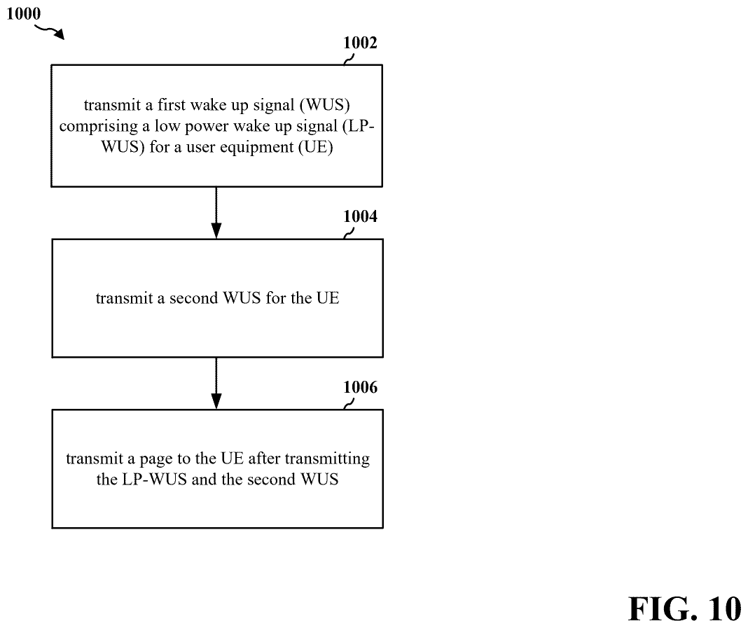

FIG. 10 is a flowchart 1000 of a method of wireless communication. The method may be performed by a network node (e.g., the base station 102, the base station 310, the network entity 1202). In an example, the method (including the various configurations described below) may be performed by the paging component 199. The method may be associated with various advantages for the network node, such as more efficient paging. At 1002, the network entity transmits a first WUS comprising a LP-WUS for a UE. For example, referring to FIG. 7, at 720, the base station 704 may transmit a LP-WUS to the UE 708.

At 1004, the network entity transmits a second WUS for the UE. For example, referring to FIG. 7, at 720, the base station 704 may transmit a PDCCH-WUS to the UE 708.

At 1006, the network entity transmits a page to the UE after transmitting the LP-WUS and the second WUS. For example, referring to FIG. 7, at 724, the base station 704 transmits a page to the UE 708.

In one configuration, the LP-WUS and the second WUS may include a same indication for the UE. For example, referring to FIG. 7, at 720, the LP-WUS and the second WUS may have a same indication.

In one configuration, the LP-WUS may include a first stage wake up indication and the second WUS may include a second stage indication. For example, FIG. 5 illustrates a two-stage wake up process.

In one configuration, the LP-WUS may be for multiple UEs associated with a PO or a PO set, and the second WUS may be for a subset of the multiple UEs associated with a paging subgroup. For example, referring to FIG. 7, at 714, the registration acceptance may include PO (or PO set) related information as well as paging subgroup information.

In one configuration, the second WUS may comprise a PDCCH-WUS. For example, referring to FIG. 5, a PDCCH-WUS is depicted. In another example, referring to FIG. 7 at 720, the base station 704 transmits a PDCCH-WUS.

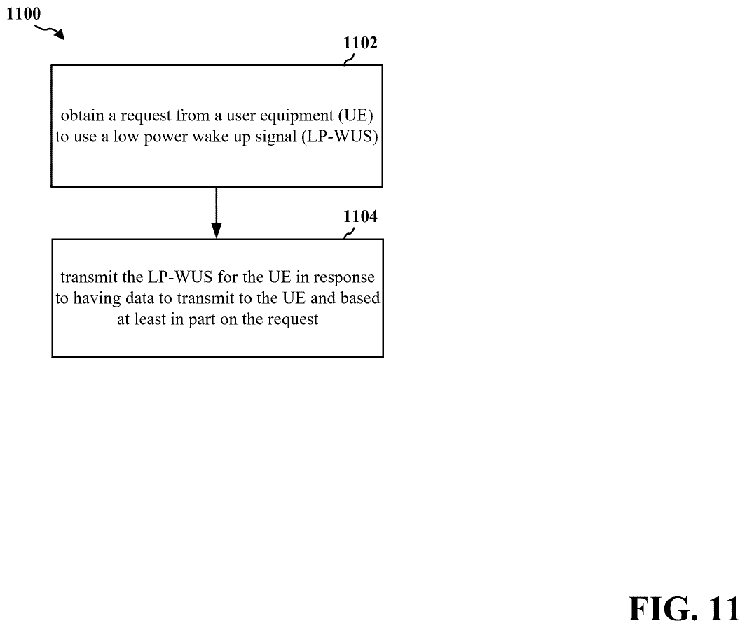

FIG. 11 is a flowchart 1100 of a method of wireless communication. The method may be performed by a network node (e.g., the base station 102, the base station 310, the network entity 1202). In an example, the method (including the various configurations described below) may be performed by the paging component 199. The method may be associated with various advantages for the network node, such as more efficient communication of data. At 1102, the network node obtains a request from a UE to use a LP-WUS. For example, referring to FIG. 7, at 710, the base station 704 may obtain a registration update request from the UE 708.

At 1104, the network node transmits the LP-WUS for the UE in response to having data to transmit to the UE and based at least in part on the request. For example, referring to FIG. 7, at 720, the base station 704 transmits a LP-WUS to the UE 708.

In one configuration, the network node may transmit a response accepting use of the LP-WUS for the UE prior to transmitting the LP-WUS. For example, referring to FIG. 7, at 714, the base station 704 transmits a registration acceptance.

In one configuration, the network node may accept the request based on at least one of a subscription of the UE or an estimated paging probability for the UE. For example, referring to FIG. 7, at 714, the registration acceptance may be based upon a subscription of the UE 708 or an estimated paging probability.

In one configuration, the network node may assign the UE to a paging subgroup associated with the LP-WUS. For example, referring to FIG. 7, at 714, the registration acceptance may include a paging subgroup ID.

In one configuration, the network node may transmit system information indicating locations of paging occasions associated with the LP-WUS. For example, referring to FIG. 7, at 714, the base station 704 may transmit system information including locations of paging occasions associated with the LP-WUS.

In one configuration, the network node may receive a paging notification for the UE from a network component, the paging notification indicating to use the LP-WUS. For example, referring to FIG. 7, at 718, the base station 704 receives a paging notification from the AMF 712.

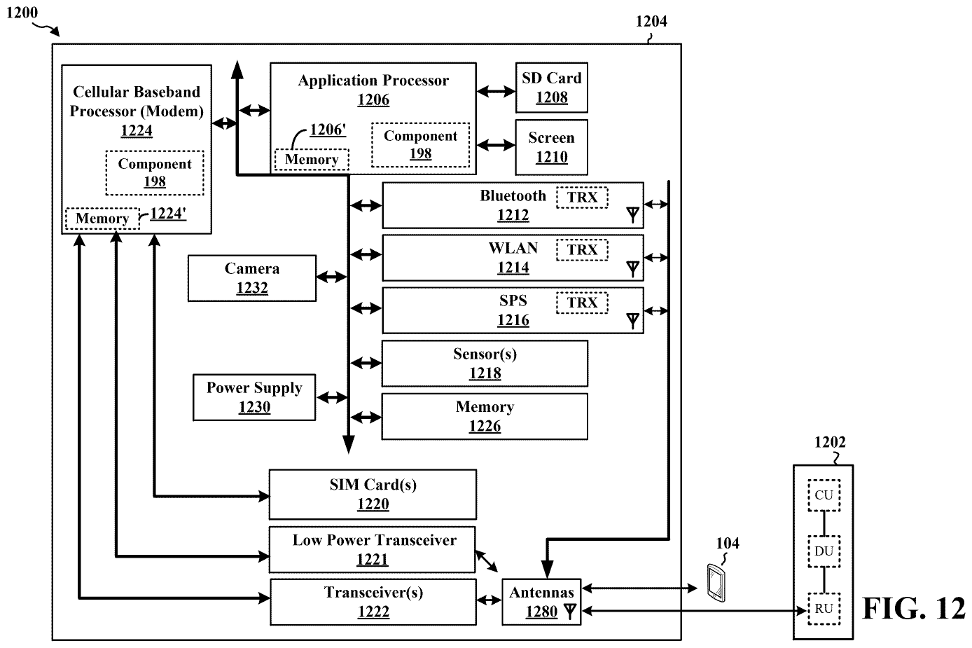

FIG. 12 is a diagram 1200 illustrating an example of a hardware implementation for an apparatus 1204. The apparatus 1204 may be a UE, a component of a UE, or may implement UE functionality. In some aspects, the apparatus1204 may include a cellular baseband processor 1224 (also referred to as a modem) coupled to one or more transceivers 1222 (e.g., cellular RF transceiver). The cellular baseband processor 1224 may include on-chip memory 1224′. In some aspects, the apparatus 1204 may further include one or more subscriber identity modules (SIM) cards 1220 and an application processor 1206 coupled to a secure digital (SD) card 1208 and a screen 1210. The application processor 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor 1224 communicates through the transceiver(s) 1221 and 1222 via one or more antennas 1280 with the UE 104 and/or with an RU associated with a network entity 1202. For example, as described in connection with FIG. 7, the apparatus may include a low power transceiver 1221 that uses less power than the transceiver(s) 1222. The cellular baseband processor 1224 and the application processor 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described supra. The computer-readable medium/memory may also be used for storing data that is manipulated by the cellular baseband processor 1224/application processor 1206 when executing software. The cellular baseband processor 1224/application processor 1206 may be a component of the UE 350 and may include the memory 360 and/or at least one of the TX processor 368, the RX processor 356, and the controller/processor 359. In one configuration, the apparatus 1204 may be a processor chip (modem and/or application) and include just the cellular baseband processor 1224 and/or the application processor 1206, and in another configuration, the apparatus 1204 may be the entire UE (e.g., see 350 of FIG. 3) and include the additional modules of the apparatus 1204.

As discussed supra, the paging receiver component 198 is configured to monitor for a LP-WUS from a network node based on meeting at least one condition and wake up to receive communication from the network node in response to receiving the LP-WUS. As discussed supra, the paging receiver component 198 is also configured to receive a first WUS comprising a LP-WUS from a network node and monitor for a second WUS from the network node in response to receiving the LP-WUS. The paging receiver component 198 may be within the cellular baseband processor 1224, the application processor 1206, or both the cellular baseband processor 1224 and the application processor 1206. The paging receiver component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1204, and in particular the cellular baseband processor 1224 and/or the application processor 1206, includes means for monitoring for a LP-WUS from a network node based on meeting at least one condition and means for waking up to receive communication from the network node in response to receiving the LP-WUS. In one configuration, the apparatus 1204, and in particular the cellular baseband processor 1224 and/or the application processor 1206, includes means for receiving a first WUS comprising a LP-WUS from a network node and means for monitoring for a second WUS from the network node in response to receiving the LP-WUS. The means may be the paging receiver component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

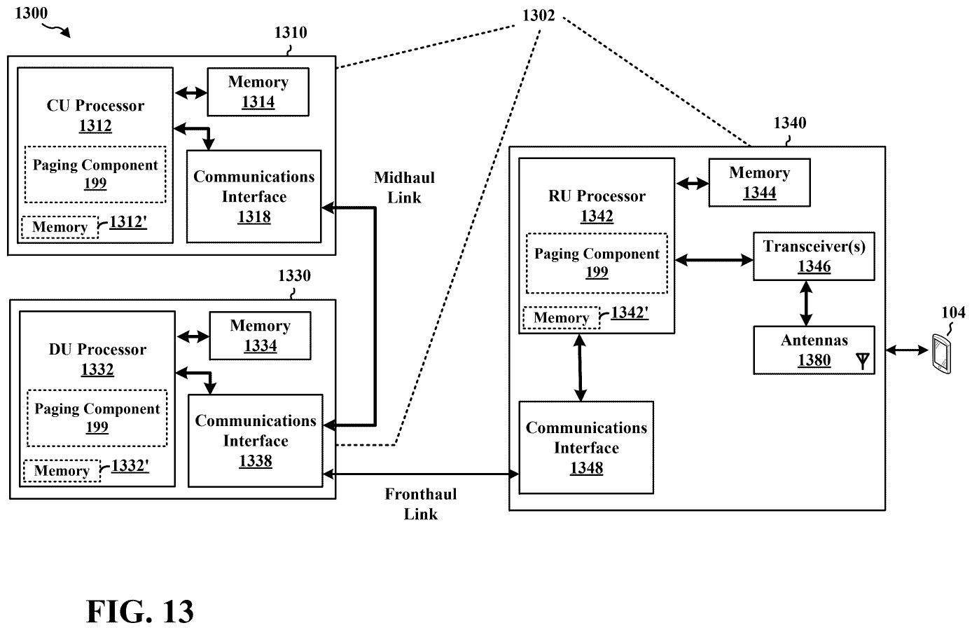

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the paging component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include a CU processor 1312. The CU processor 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include a DU processor 1332. The DU processor 1332 may include on-chip memory 1332′. In some aspects, the DU 1330 may further include additional memory modules 1334 and a communications interface 1338. The DU 1330 communicates with the RU 1340 through a fronthaul link. The RU 1340 may include an RU processor 1342. The RU processor 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the paging component 199 is configured to transmit a first WUS comprising a LP-WUS for a UE, transmit a second WUS for the UE, and transmit a page to the UE after transmitting the LP-WUS and the second WUS. As discussed supra, the paging component 199 is also configured to obtain a request from UE to use a LP-WUS and transmit the LP-WUS for the UE in response to having data to transmit to the UE and based at least in part on the request. The paging component 199 may be within one or more processors of one or more of the CU 1310, DU 1330, and the RU 1340. The paging component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1302 may include a variety of components configured for various functions. In one configuration, the network entity 1302 includes means for transmitting a first WUS comprising a LP-WUS for a UE, means for transmitting a second WUS for the UE, and means for transmitting a page to the UE after transmitting the LP-WUS and the second WUS. In one configuration, the network entity 1302 includes means for obtaining a request from a UE to use a LP-WUS and means for transmitting the LP-WUS for the UE in response to having data to transmit to the UE and based at least in part on the request. The means may be the paging component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

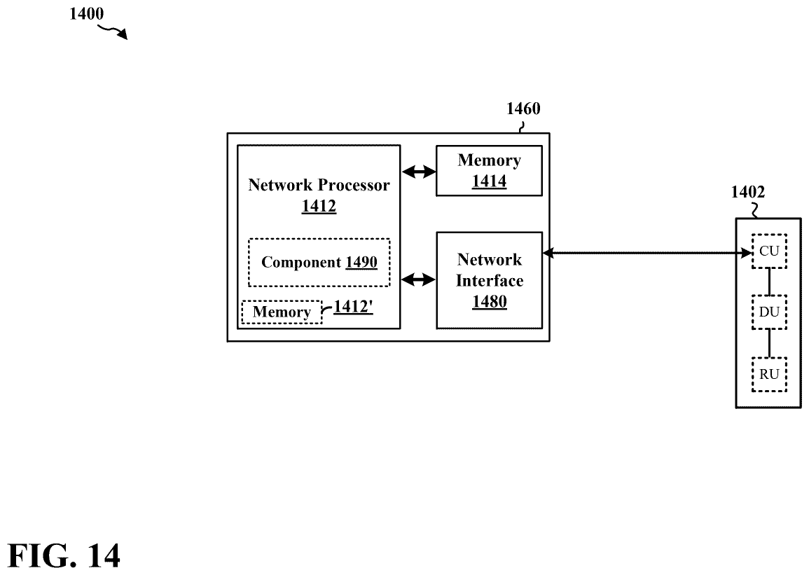

FIG. 14 is a diagram 1400 illustrating an example of a hardware implementation for a network entity 1460. In one example, the network entity 1460 may be within the core network 120. The network entity 1460 may include a network processor 1412. The network processor 1412 may include on-chip memory 1412′. In some aspects, the network entity 1460 may further include additional memory modules 1414. The network entity 1460 communicates via the network interface 1480 directly (e.g., backhaul link) or indirectly (e.g., through a RIC) with the CU 1402. The on-chip memory 1412′ and the additional memory modules 1414 may each be considered a computer-readable medium/memory. Each computer-readable medium/memory may be non-transitory. The processor 1412 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, a component 1490 is configured to perform any functionality described herein associated with the AMF 712. The component 1490 may be within the processor 1412. The component 1490 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1460 may include a variety of components configured for various functions. In one configuration, the network entity 1460 includes means for receiving a registration update from a UE, transmitting a registration acceptance from the UE, and transmitting a paging notification to a network node. The means may be the component 1490 of the network entity 1460 configured to perform the functions recited by the means.

A UE may be configured with a wakeup signal (WUS), such as a PDCCH-WUS. When configured, the UE wakes up a configurable amount of time before a start of discontinuous reception (DRX) cycle. The UE then checks for the WUS using a main radio of the UE. If the UE does not receive the WUS, the UE returns to sleep for the next DRX cycle. Waking up the main radio consumes UE power. Aspects presented herein enable a UE to receive a LP-WUS in place of or supplemental to a WUS (e.g., a PDCCH-WUS). In some aspects, the UE monitors for a LP-WUS from a network node based on meeting at least one condition. The at least one condition may include a reference signal received power (RSRP) of a downlink reference signal of the UE meeting a threshold, a location of the UE within a cell, a mobility condition of the UE, and/or a reception of an indication for a paging subgroup associated with the LP-WUS. The UE wakes up to receive communication from the network node in response to receiving the LP-WUS. Thus, the UE may consume less power monitoring for the LP-WUS in comparison to monitoring for a WUS. In some aspects, the LP-WUS is a first WUS and the UE switches to monitoring for a second WUS in response to not meeting the at least one condition. Thus, the at least one condition provides flexibility for a UE to use a LP-WUS or some other WUS (e.g., a PDCCH-WUS). In some aspects, the UE receives a first WUS comprising a LP-WUS from a network node. The UE monitors for a second WUS from the network node in response to receiving the LP-WUS. Thus, the UE may take advantage of the benefits of a WUS (wide coverage) while also taking advantages of the LP-WUS (lower UE power consumption).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, comprising monitoring for a low power wake up signal (LP-WUS) from a network node based on meeting at least one condition; and waking up to receive communication from the network node in response to receiving the LP-WUS.

Aspect 2 is the method of aspect 1, where the at least one condition is based on at least one of: a reference signal received power (RSRP) of a downlink reference signal of the UE meeting a threshold, a location of the UE within a cell, a mobility condition of the UE, or reception of an indication for a paging subgroup associated with the LP-WUS.

Aspect 3 is the method of any of aspects 1-2, further comprising: transmitting, to the network node, a request to use the LP-WUS in response to meeting the at least one condition; and receiving a response accepting use of the LP-WUS for the UE, where the at least one processor is configured to monitor for the LP-WUS after receiving the response.

Aspect 4 is the method of any of aspects 1-3, where the LP-WUS is a first WUS, further comprising: switching to monitoring for a second (WUS) in response to not meeting the at least one condition.

Aspect 5 is the method of aspect 4, wherein monitoring for the LP-WUS is performed using a first receiver, wherein monitor for the second WUS is performed using a second receiver that uses more power than the first receiver.

Aspect 6 is the method of any of aspects 1-5, further comprising: transmitting, to the network node, an indication of a change to the second WUS in response to not meeting the at least one condition.

Aspect 7 is the method of any of aspects 4-6, wherein the second WUS comprises a physical downlink control channel wake up signal (PDCCH-WUS).

Aspect 8 is the method of any of aspects 1-4 or 6-7, wherein monitoring for the LP-WUS is performed using a first receiver, wherein waking up to receive communication from the network node in response to receiving the LP-WUS comprises waking up a second receiver that uses more power than the first receiver.

Aspect 9 is the method of any of aspects 1-8, further comprising: receiving, from the network node, an indication to use a paging frame or a paging occasion associated with the LP-WUS, and to monitor for the LP-WUS in response to the indication from the network node.

Aspect 10 is the method of any of aspects 1-9, wherein the indication is comprised in a system information broadcast or in dedicated signaling.

Aspect 11 is the method of any of aspects 1-10, wherein the communication comprises a page.

Aspect 12 is the method of any of aspects 1-10, wherein the communication comprises data.

Aspect 13 is an apparatus for wireless communication at a user equipment (UE) comprising a memory and at least one processor coupled to the memory and configured to perform a method in accordance with any of aspects 1-12.

Aspect 14 is an apparatus for wireless communication, including means for performing a method in accordance with any of aspects 1-12.

Aspect 15 is the apparatus of aspect 13 or 14, further including a first receiver configured to monitor for the LP-WUS and a second receiver configured to wake up to receive the communication, where the second receiver uses more power than the first receiver.

Aspect 16 is the apparatus of aspect 15, where LP-WUS is a first WUS, where the second receiver is further configured to monitor for a second WUS.

Aspect 17 is a non-transitory computer-readable medium including instructions that, when executed by an apparatus, cause the apparatus to perform a method in accordance with any of aspects 1-12.

Aspect 18 is a method for wireless communication at a user equipment (UE), comprising: receiving a first wake up signal (WUS) comprising a low power wake up signal (LP-WUS) from a network node; and monitoring for a second WUS from the network node in response to receiving the LP-WUS.

Aspect 19 is the method of aspect 18, further comprising: waking up to receive communication from the network node in response to receiving the second WUS.

Aspect 20 is the method of aspect 19, where the communication comprises a page.

Aspect 21 is the method of aspect 19, wherein the communication comprises data.

Aspect 22 is the method of any of aspects 18-21, wherein the LP-WUS is for multiple UEs associated with a paging occasion (PO) or a PO set, and the second WUS is for a subset of the multiple UEs associated with a paging subgroup.

Aspect 23 is the method of any of aspects 18-22, further comprising: receiving a second LP-WUS; and waking up to receive second communication from the network node without monitoring for a corresponding second WUS based on a paging alarm rate being below a threshold.

Aspect 24 is the method of aspect 23, wherein the second WUS comprises a physical downlink control channel wake up signal (PDCCH-WUS).

Aspect 25 is an apparatus for wireless communication at a user equipment (UE) comprising a memory and at least one processor coupled to the memory and configured to perform a method in accordance with any of aspects 18-24.

Aspect 26 is an apparatus for wireless communication, including means for performing a method in accordance with any of aspects 18-24.

Aspect 27 is the apparatus of aspect 25 or 26, including a first receiver configured to monitor for the first WUS comprising the LP-WUS and a second receiver configured to monitor for the second WUS, where the second receiver uses more power than the first receiver.

Aspect 28 is the apparatus of aspect 27, where the second receiver is further configured to receive the communication from the network node in response to receiving the second WUS.

Aspect 29 is a non-transitory computer-readable medium including instructions that, when executed by an apparatus, cause the apparatus to perform a method in accordance with any of aspects 18-24.

Aspect 30 is a method of wireless communication at a network node, comprising: transmitting a first wake up signal (WUS) comprising a low power wake up signal (LP-WUS) for a user equipment (UE); transmitting a second WUS for the UE, and transmitting a page to the UE after transmitting the LP-WUS and the second WUS.

Aspect 31 is the method of aspect 30, where the LP-WUS and the second WUS include a same indication for the UE.

Aspect 32 is the method of any of aspects 30-31, where the LP-WUS includes a first stage wake up indication and the second WUS includes a second stage indication.

Aspect 33 is the method of any of aspects 30-32, where the LP-WUS is for multiple UEs associated with a paging occasion (PO) or a PO set, and the second WUS is for a subset of the multiple UEs associated with a paging subgroup.

Aspect 34 is the method of any of aspects 30-33, where the second WUS comprises a physical downlink control channel wake up signal (PDCCH-WUS).

Aspect 35 is an apparatus for wireless communication at a network node comprising a memory and at least one processor coupled to the memory and configured to perform a method in accordance with any of aspects 30-34.

Aspect 36 is an apparatus for wireless communication, including means for performing a method in accordance with any of aspects 30-34.

Aspect 37 is a non-transitory computer-readable medium including instructions that, when executed by an apparatus, cause the apparatus to perform a method in accordance with any of aspects 30-34.

Aspect 38 is a method of wireless communication at a network node, comprising: obtaining a request from a user equipment (UE) to use a low power wake up signal (LP-WUS); and transmitting the LP-WUS for the UE in response to having data to transmit to the UE and based at least in part on the request.

Aspect 39 is the method of aspect 38, further comprising: transmitting a response accepting use of the LP-WUS for the UE prior to transmitting the LP-WUS.

Aspect 40 is the method of any of aspects 38-39, further comprising: accepting the request based on at least one of a subscription of the UE, an estimated paging probability for the UE.

Aspect 41 is the method of any of aspects 38-40, further comprising: assigning the UE to a paging subgroup associated with the LP-WUS.

Aspect 42 is the method of any of aspects 38-41, further comprising: transmitting system information indicating locations of paging occasions associated with the LP-WUS.

Aspect 43 is the method of any of aspects 38-42, further comprising: receiving a paging notification for the UE from a network component, the paging notification indicating to use the LP-WUS.

Aspect 44 is an apparatus for wireless communication at a network node comprising a memory and at least one processor coupled to the memory and configured to perform a method in accordance with any of aspects 38-43.

Aspect 45 is an apparatus for wireless communication, including means for performing a method in accordance with any of aspects 38-43.

Aspect 46 is a non-transitory computer-readable medium including instructions that, when executed by an apparatus, cause the apparatus to perform a method in accordance with any of aspects 38-43.

Aspect 47 is the apparatus according to aspects 35 or 36, further comprising at least one transceiver configured to transmit the first WUS, transmit the second WUS, and transmit the page.

Aspect 48 is the apparatus according to aspects 44 or 45, further comprising at least one transceiver configured to obtain the request and transmit the LP-WUS.

What is claimed is:

1. An apparatus for wireless communication at a user equipment (UE), comprising:
a memory; and
at least one processor coupled to the memory and, based at least in part on information stored in the memory, the at least one processor is configured to:
monitor for a low power wake up signal (LP-WUS) from a network node based on meeting at least one condition; and
wake up to receive communication from the network node in response to receiving the LP-WUS.

2. The apparatus of claim 1, wherein the at least one condition is based on at least one of:
a reference signal received power (RSRP) of a downlink reference signal of the UE meeting a threshold,
a location of the UE within a cell,
a mobility condition of the UE, or
reception of an indication for a paging subgroup associated with the LP-WUS.

3. The apparatus of claim 1, wherein the at least one processor is further configured to:
transmit, to the network node, a request to use the LP-WUS in response to meeting the at least one condition; and
receive a response accepting use of the LP-WUS for the UE, wherein the at least one processor is configured to monitor for the LP-WUS after receiving the response.

4. The apparatus of claim 1, wherein the LP-WUS is a first WUS, and wherein the at least one processor is further configured to:
switch to monitoring for a second (WUS) in response to not meeting the at least one condition.

5. The apparatus of claim 4, further comprising:
a first receiver; and
a second receiver, wherein the second receiver uses more power than the first receiver, wherein the at least one processor is configured to monitor for the LP-WUS using the first receiver and to monitor for the second WUS using the second receiver.

6. The apparatus of claim 4, wherein the at least one processor is further configured to:
transmit, to the network node, an indication of a change to the second WUS in response to not meeting the at least one condition.

7. The apparatus of claim 4, wherein the second WUS comprises a physical downlink control channel wake up signal (PDCCH-WUS).

8. The apparatus of claim 1, further comprising:
a first receiver; and
a second receiver that uses more power than the first receiver, wherein the at least one processor is configured to monitor for the LP-WUS using the first receiver and to wake up to receive communication from the network node in response to receiving the LP-WUS comprises wake up the second receiver.

9. The apparatus of claim 1, wherein the at least one processor is further configured to:
receive, from the network node, an indication to use a paging frame or a paging occasion associated with the LP-WUS, and to monitor for the LP-WUS in response to the indication from the network node.

10. The apparatus of claim 9, wherein the indication is comprised in a system information broadcast or in dedicated signaling.

11. The apparatus of claim 1, wherein the communication comprises a page.

12. The apparatus of claim 1, wherein the communication comprises data.

13. An apparatus for wireless communication at a user equipment (UE), comprising:
a memory; and
at least one processor coupled to the memory and, based at least in part on information stored in the memory, the at least one processor is configured to:
receive a first wake up signal (WUS) comprising a low power wake up signal (LP-WUS) from a network node; and
monitor for a second WUS from the network node in response to receiving the LP-WUS.

14. The apparatus of claim 13, wherein the at least one processor is further configured to:
wake up to receive communication from the network node in response to receiving the second WUS.

15. The apparatus of claim 14, wherein the communication comprises a page.

16. The apparatus of claim 14, wherein the communication comprises data.

17. The apparatus of claim 13, wherein the LP-WUS is for multiple UEs associated with a paging occasion (PO) or a PO set, and the second WUS is for a subset of the multiple UEs associated with a paging subgroup.

18. The apparatus of claim 13, wherein the at least one processor is further configured to:
receive a second LP-WUS; and
wake up to receive second communication from the network node without monitoring for a corresponding second WUS based on a paging alarm rate being below a threshold.

19. The apparatus of claim 13, wherein the second WUS comprises a physical downlink control channel wake up signal (PDCCH-WUS).

20. An apparatus for wireless communication at a network node, comprising:
a memory; and
at least one processor coupled to the memory and, based at least in part on information stored in the memory, the at least one processor is configured to:
transmit a first wake up signal (WUS) comprising a low power wake up signal (LP-WUS) for a user equipment (UE);
transmit a second WUS for the UE; and
transmit a page to the UE after transmitting the LP-WUS and the second WUS.

21. The apparatus of claim 20, wherein the LP-WUS and the second WUS include a same indication for the UE.

22. The apparatus of claim 20, wherein the LP-WUS includes a first stage wake up indication and the second WUS includes a second stage indication.

23. The apparatus of claim 20, wherein the LP-WUS is for multiple UEs associated with a paging occasion (PO) or a PO set, and the second WUS is for a subset of the multiple UEs associated with a paging subgroup.

24. The apparatus of claim 20, wherein the second WUS comprises a physical downlink control channel wake up signal (PDCCH-WUS).

25. An apparatus for wireless communication at a network node, comprising:
a memory; and
at least one processor coupled to the memory and, based at least in part on information stored in the memory, the at least one processor is configured to:
obtain a request from a user equipment (UE) to use a low power wake up signal (LP-WUS); and
transmit the LP-WUS for the UE in response to having data to transmit to the UE and based at least in part on the request.

26. The apparatus of claim 25, wherein the at least one processor is further configured to:
transmit a response accepting use of the LP-WUS for the UE prior to transmitting the LP-WUS.

27. The apparatus of claim 25, wherein the at least one processor is further configured to:
accept the request based on at least one of a subscription of the UE, an estimated paging probability for the UE.

28. The apparatus of claim 25, wherein the at least one processor is further configured to:
assign the UE to a paging subgroup associated with the LP-WUS.

29. The apparatus of claim 28, wherein the at least one processor is further configured to:
transmit system information indicating locations of paging occasions associated with the LP-WUS.

30. The apparatus of claim 25, wherein the at least one processor is further configured to:
receive a paging notification for the UE from a network component, the paging notification indicating to use the LP-WUS.
